(19) United States
(12) Patent Application Publication
(10) Pub. No.: US 2010/0320216 A1
(43) Pub. Date: Dec. 23, 2010

(54) SURFACE-TREATED TIN-PLATED STEEL SHEET FOR WELDED CANS AND WELDED CANS MADE THEREFROM

(75) Inventors: Wataru Kurokawa, Yokohama-shi (JP); Yumi Yoshimura, Chiyoda-ku (JP); Yasufumi Tadaki, Yokohama-shi (JP); Masanobu Matsubara, Kudamatsu-shi (JP)

Correspondence Address: SUGHRUE MION, PLLC, 2100 PENNSYLVANIA AVENUE, N.W., SUITE 800, WASHINGTON, DC, 20037, US

(73) Assignees: TOYO SEIKAN KAISHA, LTD., Chiyoda-ku, Tokyo (JP); TOYO KOHAN CO., LTD., Chiyoda-ku, Tokyo (JP)

(21) Appl. No.: 12/666,261

(22) PCT Filed: Aug. 6, 2008
(86) PCT No.: PCT/JP2008/064101

§ 371 Date: Dec. 22, 2009

(30) Foreign Application Priority Data
Aug. 23, 2007 (JP) 2007-216609

(51) Int. Cl. B65D 90/02; B32B 15/04; B32B 1/00

(52) U.S. Cl. 220/680; 428/624; 428/623; 428/34.1

(57) ABSTRACT

A surface-treated tin-plated steel sheet for welded cans forming a surface-treating layer comprising chiefly a silane coupling agent on the surface of a tin-plated layer formed on the surface of a steel sheet, wherein the amount of free tin (Sn) (X g/m²) in the tin-plated layer and the amount of silicon (Si) (Y mg/m²) in the surface-treating layer lie in ranges satisfying all of the following formulas, 0.2≦X≦13, Y≧1.0, Y≦1.58X+6.92 and Y≦−0.36X+10.70. Despite of a non-chromium surface treatment, the surface-treated tin-plated steel sheet features excellent weldability, particularly high-speed weldability, close adhesion during the working and excellent corrosion resistance.

### TECHNICAL FIELD

This invention relates to a surface-treated tin-plated steel sheet for welded cans and to welded cans made from the surface-treated tin-plated steel sheet. More specifically, the invention relates to a surface-treated tin-plated steel sheet for welded cans featuring excellent weldability, close adhesion of an organic resin coating and corrosion resistance, and to welded cans.

### BACKGROUND ART

So far, materials for metal containers, such as tin-plated steel sheet (tin plate), tin-free steel (TFS), tin/nickel steel (TNS) and low tin-coated steel (LTS), usually, have a chromium-type surface-treating film comprising a chromium oxide hydrate layer or a metal chromium layer formed on the surfaces thereof in order to prevent the steel surfaces or tin-plated surfaces from being oxidized at the time of transporting the steel sheets, to improve close adhesion of the film and to improve the corrosion resistance. In the welded cans obtained by resistance welding, in particular, the amount of free tin necessary for the welding becomes in short supply as the oxidation of tin proceeds, or the tin oxide becomes a resistance against the welding, deteriorating the weldability.

On the other hand, the chromium-type surface treatment uses hexavalent chromium in the step of treatment, and it is desired to conduct the non-chromium surface treatment from the standpoint of environmental load and working environment.

A variety of non-chromium type surface treatments have also been proposed. For example, there have been proposed a seamless can comprising a laminated steel sheet featuring improved corrosion resistance by plating nickel and forming a film chiefly comprising an organic resin thereon (patent document 1), and a surface-treated steel sheet having a tin alloy layer and forming a film containing P and Si as an upper layer, the amounts of P and Si in the formed film lying in particular ranges (patent document 2).

Further, the present applicant has proposed a surface-treated tin-plated steel sheet for welded cans having a treating layer of a silane coupling agent formed on the tin-plated layer (patent document 3).

Patent document 1: JP-A-2001-262371
Patent document 2: JP-A-2002-275657
Patent document 3: JP-A-2006-001630

### DISCLOSURE OF THE INVENTION

### Problems to be Solved by the Invention

When the conventional surface-treated steel sheet is used for producing welded cans, however, the electric conductivity becomes poor due to electric resistance of the surface-treating film that contains organic matter such as silane coupling agent posing a problem in that the weldable range becomes narrow. Besides, satisfactory results are not obtained even from the standpoint of high-speed weldability.

Besides, the welded cans, too, are subjected to severe workings such as necking, beading and flanging. It is important from the standpoint of corrosion resistance that the resin film does not become defective through the above workings. For this purpose, the organic resin film must satisfy the requirement of close adhesion during the working. However, the requirement of close adhesion during the working is satisfied by none of the conventional surface-treated steel sheets that are capable of satisfying the weldability.

The welded can having the treating layer of silane coupling agent disclosed in the above patent document 3 of the present applicant is for containing chiefly fishes, shellfishes and meats that contain sulfides. Therefore, zinc is an essential component for treating the surfaces of the steel sheet to prevent discoloration of tin and to prevent the formation of iron sulfide due to hydrogen sulfide generated from the content at the time of retort treatment or while the can is being preserved. Therefore, the welded can could not cope with the content of the type of dissolving metals having a strongly corrosive acidity. Besides, when subjected to a severe working such as triple necking specific to beverage cans, the requirement of close adhesion of the resin film during the working could not be satisfied. Besides the weldability becomes poor at high speeds of 30 m/min. or higher.

It is, therefore, an object of the present invention to provide a tin-plated steel sheet for welded cans, which features excellent weldability and, particularly, high-speed weldability as well as excellent adhesion during the working and corrosion resistance despite of its non-chromium type surface treatment.

Another object of the present invention is to provide a welded can having excellent corrosion resistance and excellent appearance.

### Means for Solving the Problems

According to the present invention, there is provided a surface-treated tin-plated steel sheet for welded cans forming a surface-treating layer comprising chiefly a silane coupling agent on the surface of a tin-plated layer formed on the surface of a steel sheet, wherein the amount of free tin (Sn) (X g/m²) in the tin-plated layer and the amount of silicon (Si) (Y mg/m²) in the surface-treating layer lie in ranges satisfying all of the following formulas (1) to (4);

0.2≦X≦13 (1)

Y≧1.0 (2)

Y≦1.58X+6.92 (3)

Y≦−0.36X+10.70 (4)

In the surface-treated tin-plated steel sheet for welded cans of the present invention, it is desired that:

1. A tin-iron alloy layer is formed between the surface of the steel sheet and the tin-plated layer and, particularly, nickel is contained in the tin-iron alloy layer;
2. The silane coupling agent is a water-soluble silane coupling agent containing amino silane;
3. The steel sheet comprises a steel containing carbon in an amount of not larger than 0.10% by weight; and
4. An organic resin coating is formed on the surface-treating layer.

According to the present invention, further, there is provided a welded can formed by using the above surface-treated tin-plated steel sheet for welded cans.

### EFFECT OF THE INVENTION

The surface-treated tin-plated steel sheet for welded cans of the invention features excellent weldability and, particularly, high-speed weldability enabling the welding to be reliably carried out at a speed as high as 30 m/min.

The surface-treated tin-plated steel sheet further exhibits excellent corrosion resistance even when the can is filled with a highly corrosive acidic beverage of the type of dissolving metals.

The surface-treated tin-plated steel sheet further enables a resin coating to excellently adhere thereto and features excellent adhesion during the working even when subjected to severe working such as triple necking.

According to the present invention, further, even when the pigment concentration is increased at the time of printing, the resin coating adheres so excellently that vivid printing can be accomplished relying on the sheet printing possessed by the welded can and excellent appearance is exhibited.

### BRIEF DESCRIPTION OF THE DRAWINGS

FIG. 1 is a diagram illustrating a relationship between the amount (X) of free tin in the surface-treated tin-plated steel sheet for welded cans of the invention and the amount (Y) of Si in the treating layer of silane coupling agent.

FIG. 2 is a view illustrating a welding method.

FIG. 3 is a diagram illustrating a testing method of evaluating close adhesion in Examples.

### BEST MODE FOR CARRYING OUT THE INVENTION

As described above, the surface-treated tin-plated steel sheet for welded cans must satisfy weldability, close adhesion during the working and corrosion resistance. When the silane coupling agent is used for forming the surface-treating film, however, the weldability and, particularly, the high-speed weldability is not satisfactory. However, the treatment with the silane coupling agent works to improve the close adhesion between the tin-plated steel sheet and the organic resin film; i.e., the organic resin film exhibits improved adhesion during the working even when subjected to severe working making it possible to attain excellent corrosion resistance. The inventors, therefore, have forwarded keen study in an effort to attain excellent weldability even by using the silane coupling agent, and have discovered that it is important to satisfy a particular relationship between the thickness of the treating layer of silane coupling agent and the amount of free tin.

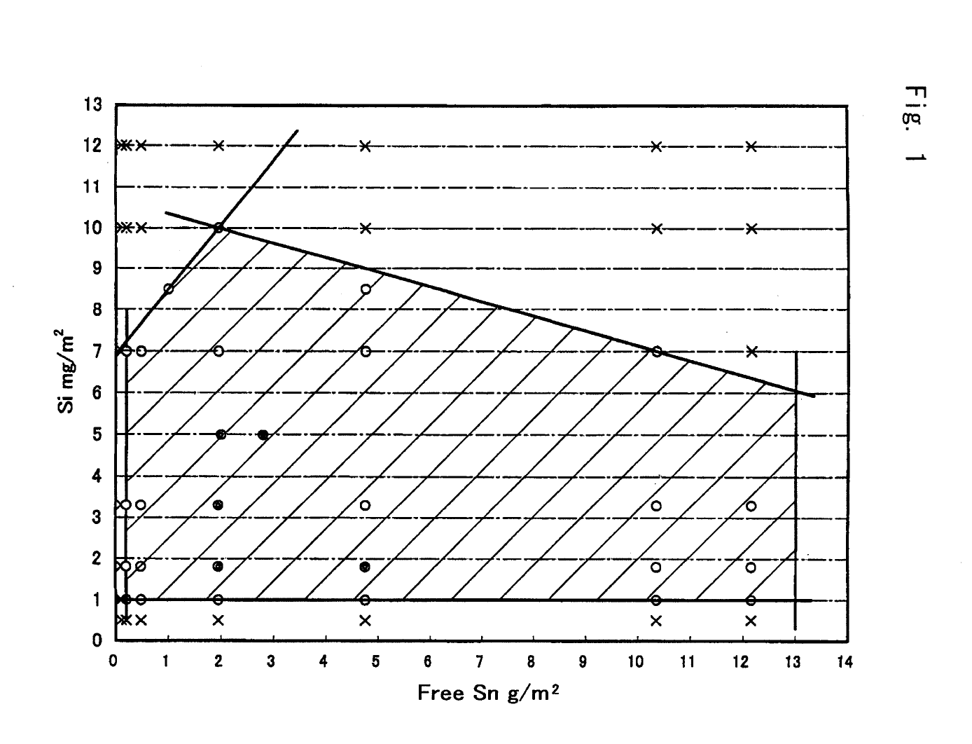

The inventors have evaluated the weldability, close adhesion and corrosion resistance while varying the amount of Si in the surface-treating layer of silane coupling agent and the amount of free tin in the tin-plated layer, and have discovered a predetermined condition for the upper limit of the amount of Si with respect to the amount of free tin. That is, referring to FIG. 1 showing the results of experiment conducted by the inventors, it was discovered that excellent weldability, close adhesion during the working and corrosion resistance can be exhibited when the amount (X) of free tin in the tin-plated layer and the amount (Y) of Si in the surface-treating layer of silane coupling agent lie in ranges (hatched ranges in FIG. 1) satisfying all of the above formulas (1) to (4).

That is, as will be obvious from FIG. 1, too, if the amount of free tin in the tin-plated layer does not satisfy the above formula (1), i.e., if X is smaller than 0.2 g/m², the amount of tin that can be used for the welding is lacking. Therefore, the welding cannot be fully conducted and the weldability is deteriorated. Besides, the surfaces of the steel sheet are not sufficiently coated with tin and the corrosion resistance becomes poor. Further, X that is larger than 13 g/m² becomes merely disadvantageous in economy and does not help further improving weldability or corrosion resistance.

If the amount of Si in the treating layer of silane coupling agent is smaller than 1.0 mg/m², the silane coupling agent exhibits a decreased effect for suppressing the oxide film and, besides, the effect is not sufficient for closely adhering the organic resin coating. This deteriorates the close adhesion after aging and close adhesion during the working (above formula (2)).

Further, referring to the above formulas (3) and (4) defining the upper limit in the amount of Si in the treating layer of silane coupling agent, it will be learned that the amount X of free tin intersects near 1.95 g/m², and the tendency of upper limit in the amount of Si that corresponds to the amount X of free tin is varying with the point of intersection as a boundary. That is, if the amount X of free tin increases up to about 1.95 g/m², the upper limit in the amount of Si increases, too. If the amount X of free tin exceeds about 1.95 g/m², however, the upper limit in the amount of Si decreases. If the above amount is exceeded, therefore, satisfactory weldability is not obtained. Further, in a range where the amount X of free tin exceeds 1.95 g/m², the close adhesion, too, decreases if the amount of Si exceeds its upper limit.

### (Tin-Plated Steel Sheet for Welded Cans)

The surface-treated tin-plated steel sheet for welded cans of the invention has a tin-plated layer and a treating layer of silane coupling agent formed on at least one surface thereof. Desirably, further, an organic resin coating and, particularly, an organic film is formed on the treating layer of silane coupling agent.

### [Steel Sheet]

The steel sheet used in the invention may be a known cold rolled steel sheet that has heretofore been used for producing welded cans. The invention, particularly desirably, uses a low-carbon steel sheet containing carbon (C) in an amount of not larger than 0.10% by weight. The weldability is affected not only by the amount of Si in the treating layer of silane coupling agent but also by the amount of C in the steel sheet. In particular, the amount of C affects the high-speed welability. That is, if the amount of C increases, splash tends to be formed at the time of welding. On the other hand, if the amount of C is small, dents tend to form in the neck and shoulder portions. According to the invention, therefore, it is desired to use a steel sheet containing C in an amount of not larger than 0.10% by weight and, particularly, in a range of 0.03 to 0.1% by weight.

It is further desired that the low-carbon steel sheet has a thickness of about 0.1 to about 0.4 mm.

### [Tin-Plated Layer]

The tin-plated layer formed on at least one surface of the steel sheet constitutes the tin-plated layer on the steel sheet and contains free tin in an amount of 0.2 to 13 g/m² as described above.

In this specification, “free tin” stands for metal tin which is not forming an alloy with iron or nickel.

In the invention, the tin-plated layer is formed on the steel sheet in such a manner that the amount of free tin lies in the above-mentioned range, and the reflow treating temperature, treating time and heating/firing condition after the organic resin coating is formed are controlled so as to improve the corrosion resistance of the steel sheet itself. Further, the surface is treated by using the silane coupling agent to improve weldability, adhesion to the organic resin coating during the working and adhesion after aging in order to further improve the corrosion resistance after the working. The tin-plated layer may uniformly cover the surface of the steel sheet or may cover the surface in the form of islands.

The tin-plated layer is formed on at least one surface of the steel sheet, i.e., on the surface on the inner side of the can. Desirably, however, the tin-plated layer may also be formed on the other surface which is on the outer side of the can. The amount of tin may be the same as, or different from, the amount on the surface on the inner side of the can. It is desired that a difference in the amount of tin plating between the inner surface of the can and the outer surface of the can is not larger than 6 g/m² from economical point of view.

In the invention, the tin-plated layer formed on the steel sheet may be partly a tin-iron alloy on the side of the steel sheet to obtain a two-layer constitution of tin-plated layer/tin-iron alloy layer. Formation of the tin-iron alloy layer improves close adhesion during the working and, further, improves the corrosion resistance of the steel sheet itself.

To form the tin-plated layer in the two-layer constitution of tin-plated layer/tin-iron alloy layer, tin is plated in a predetermined amount on the steel sheet, followed by heating at a temperature higher than the melting point of tin and, thereafter, by cooling (reflow treatment) to thereby transform part of the tin-plated layer on the side of the steel sheet into the iron-tin alloy layer.

In the invention, it is particularly desired to form a thin nickel-plated layer or a thin nickel diffusion layer in advance on the surface of the steel sheet prior to plating tin in order transform part thereof on the side of the steel sheet into a tin-nickel-iron alloy. This makes it possible to form a fine alloy layer suppressing free tin from being transformed into an alloy thereof. In the present invention as described above, it is important that even when an alloy layer is formed, the amount of free tin which has not been transformed into an alloy thereof lies within the above-mentioned range.

It is desired that the tin-plated layer contains no zinc. If zinc is contained as described above, it is not possible to obtain corrosion resistance that can be applied, particularly, to corrosive contents of the type of dissolving metals and, besides, close adhesion during the working is deteriorated. Further, at the time of high-speed welding, splashes and blow holes occur to deteriorate the weldability.

### [Treating Layer of Silane Coupling Agent]

The treating layer of silane coupling agent formed on the tin-plated layer works to improve close adhesion between the tin-plate layer or the tin-iron alloy layer and the organic resin film due to the reaction group possessed by the silane coupling agent. Further, the treating layer of silane coupling agent itself improves the durability and resistance against water while suppressing gases from permeating into the tin-plated layer. This suppresses the tin-plated layer from forming an oxide film thereof and prevents a drop in the close adhesion of the organic resin coating caused by the formation and growth of oxide film.

According to the present invention as described above, the upper limit of the amount of Si in the treating layer of silane coupling agent is determined in relation to the amount of free tin in the tin-plated layer. With the amount of free tin of about 2.0 g/m² (X=1.95 g/m²) as a boundary, it is important that the amount of Si satisfies the above formula (3) if the amount of free tin is smaller than the above value and that the amount of Si satisfies the above formula (4) if the amount of free tin is not smaller than the above value. The lower limit of the amount of Si is 1.0 mg/m².

The silane coupling agent used for forming the surface-treating layer of silane coupling agent has a reaction group that chemically bonds to the organic resin coating and a reaction group that chemically bonds to the tin-plated steel sheet, and may be an organosilane having such a reaction group as vinyl group, styryl group, acryloxy group, ureido group, chloropropyl group, sulfide group, isocyanate group, amino group, epoxy group, methacryloxy group or mercapto group, and a hydrolyzing alkoxy group such as methoxy group or ethoxy group, or a silane containing an organic substituent such as methyl group or phenyl group and a hydrolyzing alkoxy group.

Concrete examples of the silane coupling agent that can be preferably used in the invention include γ-APS(γ-aminopropyltrimethoxysilane), γ-GPS(γ-glycidoxypropyltrimethoxysilane), BTSPA(bistrimethoxysilylpropylaminosilane), and N-β (aminoethyl) γ-aminopropyltrimethoxysilane.

The treating layer of silane coupling agent can be formed on the tin-plated layer by applying a solution of the silane coupling agent onto the tin-plated layer or by dipping the steel sheet forming the tin-plated layer in the solution of the silane coupling agent and, thereafter, removing an excess of solution by using squeeze rolls. Preferred combinations of solutions of silane coupling agents and the order of treatments are as described below.

(1) Formed by using a solution of an amino group-containing silane coupling agent and/or a solution of an epoxy group-containing silane coupling agent.
(2) Formed by using a mixed solution comprising a solution of an amino group-containing silane coupling agent and/or a solution of an epoxy group-containing silane coupling agent, and a silane containing an organic substituent and a hydrolyzing alkoxy group. Due to the mixed treatment, it is expected to obtain the effect of maintaining the close adhesion at a higher level even after the retort treatment.
(3) Formed by the treatment with a silane having an organic substituent and a hydrolyzing alkoxy group and, thereafter, by the treatment by using a solution of silane coupling agents comprising a solution of an amino group-containing silane coupling agent and/or a solution of an epoxy group-containing silane. Through the two-step treatment, the treating solution maintains stability after aging that is not attained by the mixed treatment, and it can be expected to maintain close adhesion at a higher level even after the retort treatment.

### [Organic Resin Coating]

In the present invention, the organic resin coating formed on the treating layer of silane coupling agent may be a thermoplastic resin film or a film formed by applying a thermosetting coating material. From the standpoint of close adhesion, however, an organic film formed by applying an organic resin coating material is desired.

As the organic resin coating material, there can be used a known thermosetting coating material that has heretofore been used for coating metal cans, such as epoxy coating material, phenol coating material, acrylic coating material and urethane coating material. From the standpoint of workability, in particular, it is desired to use a water-soluble coating material without containing organic solvent. It is, therefore, desired to use an epoxy/acrylic aqueous coating material.

As the resin film that can be used for the organic resin coating, a known thermoplastic resin can be exemplified, such as polyolefin resin, thermoplastic polyester resin and the like.

However, it is most desired to use a thermoplastic polyester resin. The thermoplastic polyester resin little adsorbs fragrant components in the content, and exhibits excellent barrier property against corrosive components and shock resistance.

As the thermoplastic polyester resin, there can be used a polyester resin derived from a known carboxylic acid component and an alcohol component, which may be a homopolyester, a copolymerized polyester or a blend of two or more kinds thereof.

In the invention, among the known thermoplastic polyester resins, it is particularly desired to use a polyethylene terephthalate-type copolymerized resin, i.e., an ethylene terephthalate-type copolymerized polyester resin in which not less than 50 mol % of the carboxylic acid component is a terephthalic acid and not less than 50 mol % of the alcohol component is an ethylene glycol component. Desirably, polyethylene terephthalate/isophthalate can be used containing 3 to 18 mol % of isophthalic acid as carboxylic acid component.

It is desired that the polyester resin that is used has a molecular weight capable of forming a film and has an intrinsic viscosity [η] a range of 0.6 to 1.2 as measured in orthochlorophenol at 25° C.

As required, further, the thermoplastic film can be arranged via an adhesive primer resin such as epoxyphenol resin or epoxyacrylic resin.

Any known means can be employed, such as extrusion coating method, cast film heat-adhesion method or film heat-adhesion method for forming the resin film layer on the steel sheet on which the treating layer of silane coupling agent has been formed.

When a film is to be used, the film is obtained by a T-die method or an inflation film-forming method. Desirably, the film is an undrawn film obtained by the cast-forming method by quickly quenching the extruded film, since the film has no distortion and features excellent workability and close adhesion. It is, however, also allowable to use a biaxially drawn film obtained by successively or simultaneously biaxially drawing the film at a drawing temperature and thermally setting the film after it has been drawn.

When an organic film is formed as the organic resin coating, it is desired that the thickness thereof is in a range of 1 to 16 μm and, particularly, 3 to 10 μm. Further, when a resin film layer is formed, it is desired that the thickness thereof is in a range of 8 to 42 μm and, particularly, 10 to 40 μm from the standpoint of balance between protecting the surface-treated tin-plated steel sheet and the workability. If the thickness of the organic resin coating is smaller than the above range, barrier property decreases, corrosion occurs due to the infiltration of the content, the coating is easily scratched at the time of working, and the probability of occurrence of corrosion increases. If the thickness is larger than the above range, on the other hand, the rigidity of the film itself increases, and the adhesion during the working is deteriorated at the necking portion and the wrap-seamed portion that are subjected to severe working.

Further, the organic resin coating is formed on the treating layer of silane coupling agent but excluding the welding portion and the vicinity thereof from the standpoint of weldability.

### [Layer Constitution]

As described above, the surface-treated tin-plated steel sheet for welded cans of the invention has the tin-plated layer, treating layer of silane coupling agent and organic resin coating formed in this order on at least one surface of the steel sheet. Preferably, further, a tin-iron alloy layer or a tin-iron-nickel alloy layer is formed between the surface of the steel sheet and the tin-plated layer. As required, further, any other layer may be formed. That is, the tin-plated layer and the organic resin coating may be provided even on the other surface of the steel sheet which is on the outer surface side of the can like on the inner surface side. Besides, a white coating and a printed layer may be provided on the organic resin coating, as a matter of course. In particular, the surface-treated tin-plated steel sheet for welded cans of the invention features excellent adhesiveness making it possible to increase the content of pigment in the printed layer and in the underlying layer, and exhibits excellent appearance.

### (Welded Can)

The welded can of the invention is obtained by effecting the welding in a state where both edge portions of the can body blank comprising a surface-treated tin-plated steel sheet coated with the above organic resin are overlapped over a width of not larger than 1 mm and, particularly, not larger than 0.4 mm. The welding conditions desirably consist of a welding speed in a range of 30 to 120 m/min. and a welding pressure in a range of 40 to 60 kgf. Excellent weldability can be expressed even at a high welding speed of, particularly, 55 m/min. or higher.

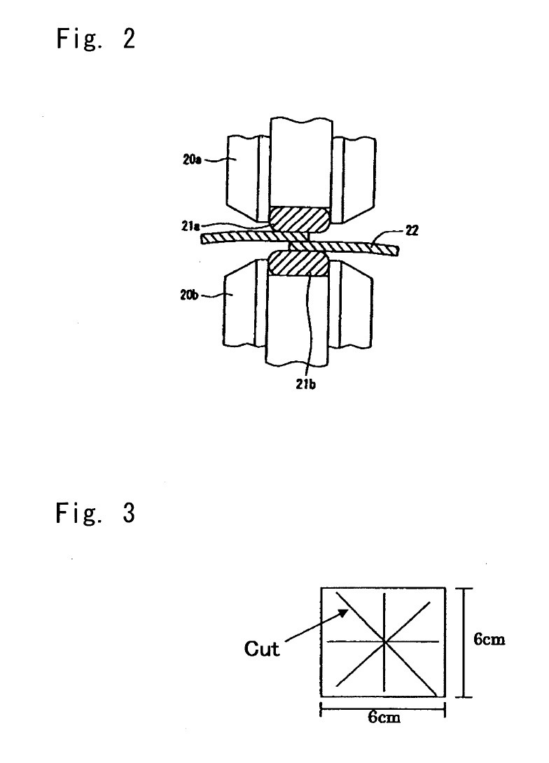

FIG. 2 is a view illustrating the welding in which a seam is welded by holding an overlapped portion 23 of the organic resin-coated surface-treated steel sheet 22 by using electrode rolls 20a and 20b or by using welding copper wires 21a and 21b backed up by the electrode rolls 20a and 20b and, thereafter, the metal exposed at the welded portion is mended by using the thermosetting coating material.

Next, the necking, beading and flanging are effected to form the can body portion. Next, separately formed can end portions (can lid and can bottom) are wrap-seamed to form a welded can. The welded can of the invention can be favorably used for containing beverages, and its diameter can be contracted by necking to a high degree like that of triple necking.

As required, further, the inner surface of the can before or after the necking can be partly or entirely spray-coated. Preferred examples of the coating material for being sprayed include an epoxyacrylic coating material and an epoxyphenol coating material.

The welded can of the invention has excellent corrosion resistance and can be preferably used for containing beverages such as metal-corroding acidic beverages. The welded can be further desirably used as an aerosol can, an 18-liter can for containing solvent and the like, to which only, however, the invention is not limited.

### EXAMPLES

### Preparation of the Surface-Treated Tin-Plated Steel Sheet

By using a low-carbon steel sheet containing carbon in an amount of 0.04% by weight and having a thickness of 0.22 mm, Sn was so plated that the amounts of free Sn after the reflow treatment were as shown in Tables 1 and 2. Next, onto the reflow-treated material, a solution of aminosilane coupling agent (γ-aminopropyltrimethoxysilane) was applied at a speed of 50 m/min. by a roll-coating method while varying the diluted concentration in a manner that the amounts of Si after drying were as shown in Table 1, followed by drying with the hot air of 150° C. to obtain surface-treated tin-plated steel sheets (samples Nos. 1 to 76).

The material of sample No. 77 was a tin-plated steel sheet obtained by being treated in the same manner as described above but without effecting the reflow treatment.

In Tables 1 and 2, numerical values were measured by the methods described below.

### (1) Measuring the Amount of Si in the Treating Layer of Silane Coupling Agent.

Test pieces before and after applying the silane coupling agent were measured for their amounts of Si by a fluorescent X-ray method to find by calculation the amount of Si from a difference between the two.

### (2) Measuring the Amount of Carbon in the Steel Plate.

A sample put into a crucible was burned by high-frequency heating in an oxygen stream, and the generated CO₂ concentration was analyzed by an infrared ray analyzer to find the amount of C in the steel. The measuring apparatus was a “Carbon-in-Solid Analyzer, EMIA-921V, manufactured by Horiba Seisakusho Co.”.

### (3) Measuring the Amount of Free Tin in the Tin-Plated Layer.

By using a surface-treated tin-plated steel sheet of before being coated with a resin, test pieces of before and after electrochemically dissolving metal tin (free tin) were measured for their amounts of tin by the fluorescent X-ray method in compliance with the JIS G3303 to find by calculation the amount of free tin from a difference between the two.

### (Preparation of the Resin-Coated Surface-Treated Tin-Plated Steel Sheet)

The materials of samples Nos. 1 to 73 and 77 were the resin-coated tin-plated steel sheets obtained by coating the above tin-plated steel sheet with an epoxyacrylic phenol type aqueous coating material except the welding margin portion which is a seam portion of the can body in such a manner that the film thickness after firing was 5 μm on the inner surface side and 3 μm on the outer surface side, effecting the firing and curing in a hot air drying furnace at 185° C. for 10 minutes and 205° C. for 10 minutes and, thereafter, similarly printing the outer surface, too, leaving the welding margin portion.

The material of the sample No. 74 was the resin-coated tin-plated steel sheet obtained like those of the samples Nos. 1 to 73 but extrusion-coating the inner surface side of the can with a polyester resin (polyethylene terephthalate resin copolymerized with 10 mol % of isophthalic acid) leaving the welding margin portion such that the thickness of the resin film on the inner surface was 28 μm.

The material of the sample No. 75 was the resin-coated tin-plated steel sheet obtained like those of the samples Nos. 1 to 73 but laminating a biaxially drawn polyethylene terephthalate/isophthalate film (melting point, 230° C.) of a thickness of 20 μm on which an epoxyphenol type adhesive primer has been applied in advance onto the inner surface side of the can leaving the welding margin portion.

The material of the sample No. 76 was the resin-coated tin-plated steel sheet obtained like those of the samples Nos. 1 to 73 but applying the epoxyphenol type coating material onto the inner surface side of the can in a manner that the thickness of the coating was 65 mg/dm².

### (Preparation of Welded Cans)

The materials of the samples Nos. 1 to 77, i.e., the resin-coated surface-treated tin-plated steel sheets, were so cut that the vicinities of the blank edges became the welding margin portions. By using a copper wire seam-welding machine manufactured by Soudronic Co., the blanks were welded while overlapping the welding portions over a width of 0.3 mm in a cylindrical shape. The welding conditions consisted of a welding speed of 55 m/min and a welding pressing force of 50 kgf.

Next, the materials of samples Nos. 1 to 73, 76 and 77 were formed into welded can bodies (can diameter of 65.4 mm, can body height of 122 mm) by spray-coating the inner and outer surfaces of the weld-seaming portions of can bodies with a solvent type epoxyphenol mending coating material in a manner that the thickness of the coating after drying was 35 μm, and covering the seam portions by firing in a hot air dry furnace at 220° C. for 40 seconds. Lids were wrap-seamed to the can bodies on one side thereof, and the opening ends were necked up to 60.3 mm relying on a die-necking in three steps.

The materials of samples Nos. 74 and 75 were formed into welded can bodies in the same manner as described above but applying a polyester powder onto the inner surface side of the can bodies at the weld-seaming portions in a manner that the thickness of the film after drying was 70 μm and firing the powder-coated portions only at 240° C. for 3 seconds in the hot air drying furnace.

### (Evaluation of Containers)

### 1. Evaluation of Weldability.

The welding voltage was regarded to be the upper limit when the splash and blow holes occurred, was regarded to be the lower limit when there was even a small portion that had not been welded in the welded portion peel testing, and the weldability was evaluated based on the number of voltage points therebetween on the following basis. The welded cans could be stably produced when they were evaluated to be ⊚ and ◯. The occurrence of splash was observed by naked eyes and the occurrence of blow holes was observed by the permeation of X-rays.
⊚: Weldable range included 4 or more points.
◯: Weldable range included not less than 3 points but less than 4 points.
Δ: Weldable range included not less than 2 points but less than 3 points.
X: Weldable ranges included less than 2 points.

In evaluating the can bodies, the materials evaluated to be X were welded by changing the welding conditions over to more easily welding conditions (welding pressing force of 55 kgf, welding speed of 15 m/min.), and were evaluated. For the materials that could not be welded even under this conditions, the can bodies were not evaluated.

### 2. Evaluation of Corrosion Resistance.

The can bodies were cut opened, test pieces measuring 60 mm×60 mm were cut out from the portions other than the welded portions, and the inner surfaces of the cans were evaluated for their corrosion resistances. The edges were covered with a protection tape so that corrosion did not take place from the ends of the test pieces. Thereafter, the test pieces were dipped in a solution of 1.5% NaCl+1.5% citric acid at 37° C. for 12 days. The corroded state was evaluated into 5 steps by eyes. The evaluation was made on the following basis. The products were acceptable when they were evaluated to be ⊚ and ◯.
⊚: Corroded area was less than 20% of the whole area.
◯: Corroded area was not less than 20% but was less than 40% of the whole area.
Δ: Corroded area was not less than 40% but was less than 60% of the whole area.
X: Corroded area was not less than 60% of the whole area.

### 3. Evaluation of Close Adhesion.

### (a) Close Adhesion of can Body Portions.

Like the case of evaluating the corrosion resistance, test pieces measuring 60 mm×60 mm were cut out from flat portions of the can bodies. Thereafter, the coatings on inner surface side of the cans were cut by using a cutter in 8 directions (see FIG. 3) to use them as test pieces. The test pieces were retort-treated in water at 116° C. for 60 minutes. After the retort treatment, the test pieces were evaluated as quickly as possible. The test pieces were put in water until just before being evaluated. After having wiped off the water, Cellotape (registered trademark) (24 mm wide) manufactured by Nichiban Co. was stuck thereto and, thereafter, a peeling test was repeated twice to evaluate the close adhesion.

### (b) Close Adhesion of Neck Portions.

The opening portion of the can body on the side necked in 3 steps was divided into four to prepare four quarter-circular test pieces. By using a cutter, three cuts were formed in the inner surface side of the neck portion of the can body along the steps in parallel with the circumferential direction. Thereafter, the test pieces were retort-treated in water at 116° C. for 60 minutes. After the retort treatment, the test pieces were evaluated as quickly as possible. The test pieces were put in water until just before being evaluated. After having wiped off the water, Cellotape (registered trademark) (24 mm wide) manufactured by Nichiban Co. was stuck thereto and, thereafter, a peeling test was repeated twice to evaluate the close adhesion.

Close adhesion of the can body portions and close adhesion of the neck portions were evaluated on the following basis.
5 Points: Cut portions developing peeling in the peripheries thereof were 0% of the whole cut portions.
4 Points: Cut portions developing peeling in the peripheries thereof were less than 3% of the whole cut portions.
3 Points: Cut portions developing peeling in the peripheries thereof were not less than 3% but were less than 10% of the whole cut portions.
2 Points: Cut portions developing peeling in the peripheries thereof were not less than 10% but were less than 20% of the whole cut portions.
1 Point: Cut portions developing peeling in the peripheries thereof were not less than 20% but were less than 50% of the whole cut portions.
0 Point: Cut portions developing peeling in the peripheries thereof were not less than 50% of the whole cut portions.

The close adhesion was totally evaluated to be X when the total score of the two evaluations was less than 4 points, to be Δ when the total score was 5 to 6 points, to be ◯ when the total score was 7 to 8 points, and was evaluated to be ⊚ when the total score was not less than 9 points. The products were acceptable when they were evaluated to be ⊚ and ◯.

4. Evaluation of Close Adhesion after Aging.

The surface-treated steel sheets without, however, coated with the resin were preserved at room temperature for 6 months. The thus preserved steel sheets were coated with the resin and were evaluated in the same manner as evaluating the close adhesion of the can body portions. The close adhesion was evaluated to be X when the score was not larger than 2 points, to be ◯ when the score was 3 to 4 points, and to be ⊚ when the score was 5 points. The products were acceptable when they were evaluated to be ⊚ and ◯.

### 5. Total Decision.

Based on the evaluation of weldability, evaluation of corrosion resistance, total evaluation of close adhesion and evaluation of close adhesion after aging, the total decision was rendered on the following basis. The products were when they acceptable were evaluated to be ⊚ and ◯.
⊚: Evaluations were all ⊚.
◯: Evaluations were all ⊚ or ◯.
X: Any evaluation was Δ or X.

Table 1 shows the results of evaluations and decisions of the above five kinds. Symbol “-” represents no evaluation since the welding could not be effected.

FIG. 1 shows the results of total evaluation as obtained by preparing a diagram of relationship between the amounts of free Sn and the amounts of Si from the results of Tables 1 and 2. It will be learned that favorable properties are exhibited when the amount of free Sn (X g/m²) and the amount of Si (Y mg/m²) in the surface-treating layer are in such ranges that satisfy all of the following formulas,

0.2≦X≦13

Y≧1.0

Y≦1.58X+6.92

Y≦−0.36X+10.70

TABLE 1

| | | Free | | | | Close adhesion | | | Close | |
|---|---|---|---|---|---|---|---|---|---|---|
| Sample | | Sn | Si | | Corrosion | Can | | | adhesion | Total |
| No. | | g/m² | mg/m² | Weldability | resistance | body | Neck | Total | after aged | decision |
| 1 | Comp. Ex. | 0.11 | 0.5 | Δ | X | 5 | 5 | ⊚ | X | X |
| 2 | Comp. Ex. | 0.20 | 0.5 | ⊚ | X | 5 | 5 | ⊚ | X | X |
| 3 | Comp. Ex. | 0.48 | 0.5 | ⊚ | ◯ | 5 | 5 | ⊚ | X | X |
| 4 | Comp. Ex. | 2.0 | 0.5 | ⊚ | ⊚ | 5 | 5 | ⊚ | X | X |
| 5 | Comp. Ex. | 4.8 | 0.5 | ⊚ | ⊚ | 5 | 5 | ⊚ | X | X |
| 6 | Comp. Ex. | 10.4 | 0.5 | ⊚ | ⊚ | 5 | 5 | ⊚ | X | X |
| 7 | Comp. Ex. | 12.2 | 0.5 | ⊚ | ⊚ | 5 | 5 | ⊚ | X | X |
| 8 | Comp. Ex. | 0.11 | 1.0 | Δ | Δ | 5 | 5 | ⊚ | ◯ | X |
| 9 | Ex. | 0.20 | 1.0 | ⊚ | ◯ | 5 | 5 | ⊚ | ◯ | ◯ |
| 10 | Ex. | 0.48 | 1.0 | ⊚ | ◯ | 5 | 5 | ⊚ | ◯ | ◯ |
| 11 | Ex. | 2.0 | 1.0 | ⊚ | ⊚ | 5 | 5 | ⊚ | ◯ | ◯ |
| 12 | Ex. | 4.8 | 1.0 | ⊚ | ⊚ | 5 | 5 | ⊚ | ◯ | ◯ |
| 13 | Ex. | 10.4 | 1.0 | ⊚ | ⊚ | 5 | 5 | ⊚ | ◯ | ◯ |
| 14 | Ex. | 12.2 | 1.0 | ⊚ | ⊚ | 5 | 5 | ⊚ | ◯ | ◯ |
| 15 | Comp. Ex. | 0.11 | 1.8 | Δ | Δ | 5 | 5 | ⊚ | ⊚ | X |
| 16 | Ex. | 0.20 | 1.8 | ⊚ | ◯ | 5 | 5 | ⊚ | ⊚ | ◯ |
| 17 | Ex. | 0.48 | 1.8 | ⊚ | ◯ | 5 | 5 | ⊚ | ⊚ | ◯ |
| 18 | Ex. | 2.0 | 1.8 | ⊚ | ⊚ | 5 | 5 | ⊚ | ⊚ | ⊚ |
| 19 | Ex. | 4.8 | 1.8 | ⊚ | ⊚ | 5 | 5 | ⊚ | ⊚ | ⊚ |
| 20 | Ex. | 10.4 | 1.8 | ⊚ | ⊚ | 5 | 5 | ⊚ | ⊚ | ⊚ |
| 21 | Ex. | 12.2 | 1.8 | ⊚ | ⊚ | 5 | 5 | ⊚ | ⊚ | ⊚ |
| 22 | Comp. Ex. | 0.11 | 3.3 | X | Δ | 5 | 5 | ⊚ | ⊚ | X |
| 23 | Ex. | 0.20 | 3.3 | ◯ | ◯ | 5 | 5 | ⊚ | ⊚ | ◯ |
| 24 | Ex. | 0.48 | 3.3 | ⊚ | ◯ | 5 | 5 | ⊚ | ⊚ | ◯ |
| 25 | Ex. | 2.0 | 3.3 | ⊚ | ⊚ | 4 | 5 | ⊚ | ⊚ | ⊚ |
| 26 | Ex. | 4.8 | 3.3 | ⊚ | ⊚ | 3 | 4 | ◯ | ⊚ | ◯ |
| 27 | Ex. | 10.4 | 3.3 | ⊚ | ⊚ | 3 | 4 | ◯ | ⊚ | ◯ |
| 28 | Ex. | 12.2 | 3.3 | ⊚ | ⊚ | 4 | 5 | ⊚ | ⊚ | ⊚ |
| 29 | Comp. Ex. | 0.11 | 7 | X | Δ | 5 | 5 | ⊚ | ⊚ | X |
| 30 | Ex. | 0.20 | 7 | ◯ | ◯ | 5 | 5 | ⊚ | ⊚ | ◯ |
| 31 | Ex. | 0.48 | 7 | ◯ | ◯ | 5 | 5 | ⊚ | ⊚ | ◯ |
| 32 | Ex. | 2.0 | 7 | ⊚ | ⊚ | 3 | 5 | ◯ | ⊚ | ◯ |
| 33 | Ex. | 4.8 | 7 | ◯ | ⊚ | 3 | 4 | ◯ | ⊚ | ◯ |
| 34 | Ex. | 10.4 | 7 | ◯ | ⊚ | 3 | 4 | ◯ | ⊚ | ◯ |
| 35 | Comp. Ex. | 12.2 | 7 | ◯ | ⊚ | 1 | 5 | Δ | ⊚ | X |
| 36 | Ex. | 1.0 | 8.5 | ◯ | ◯ | 4 | 4 | ◯ | ⊚ | ◯ |
| 37 | Ex. | 4.8 | 8.5 | ◯ | ⊚ | 3 | 4 | ◯ | ⊚ | ◯ |

TABLE 2

| | | Free | | | | Close adhesion | | | Close | |
|---|---|---|---|---|---|---|---|---|---|---|
| Sample | | Sn | Si | | Corrosion | Can | | | adhesion | Total |
| No. | | g/m² | mg/m² | Weldability | resistance | body | Neck | Total | after aged | decision |
| 38 | Comp. Ex. | 0.11 | 10 | X | ◯ | 5 | 5 | ⊚ | ⊚ | X |
| 39 | Comp. Ex. | 0.20 | 10 | Δ | ◯ | 5 | 5 | ⊚ | ⊚ | X |
| 40 | Comp. Ex. | 0.48 | 10 | Δ | ◯ | 5 | 5 | ⊚ | ⊚ | X |
| 41 | Ex. | 2.0 | 10 | ⊚ | ⊚ | 3 | 4 | ◯ | ⊚ | ◯ |
| 42 | Comp. Ex. | 4.8 | 10 | Δ | ⊚ | 2 | 4 | Δ | ⊚ | X |
| 43 | Comp. Ex. | 10.4 | 10 | Δ | ⊚ | 1 | 4 | Δ | ⊚ | X |
| 44 | Comp. Ex. | 12.2 | 10 | Δ | ⊚ | 1 | 4 | Δ | ⊚ | X |
| 45 | Comp. Ex. | 0.11 | 12 | Δ | ◯ | 5 | 5 | ⊚ | ⊚ | X |
| 46 | Comp. Ex. | 0.20 | 12 | X | ◯ | 5 | 5 | ⊚ | ⊚ | X |
| 47 | Comp. Ex. | 0.48 | 12 | Δ | ⊚ | 5 | 5 | ⊚ | ⊚ | X |
| 48 | Comp. Ex. | 2.0 | 12 | ◯ | ⊚ | 1 | 3 | X | ⊚ | X |
| 49 | Comp. Ex. | 4.8 | 12 | Δ | ⊚ | 1 | 3 | X | ⊚ | X |
| 50 | Comp. Ex. | 10.4 | 12 | Δ | ⊚ | 1 | 4 | Δ | ⊚ | X |
| 51 | Comp. Ex. | 12.2 | 12 | X | ⊚ | 1 | 4 | Δ | ⊚ | X |
| 52 | Comp. Ex. | 0.11 | 25 | X | ◯ | 5 | 5 | ⊚ | ⊚ | X |
| 53 | Comp. Ex. | 0.20 | 25 | X | ◯ | 5 | 5 | ⊚ | ⊚ | X |
| 54 | Comp. Ex. | 0.48 | 25 | X | ⊚ | 4 | 5 | ⊚ | ⊚ | X |
| 55 | Comp. Ex. | 2.0 | 25 | Δ | ⊚ | 0 | 3 | X | ◯ | X |
| 56 | Comp. Ex. | 4.8 | 25 | X | ⊚ | 0 | 2 | X | ◯ | X |
| 57 | Comp. Ex. | 10.4 | 25 | X | ⊚ | 1 | 3 | X | ◯ | X |
| 58 | Comp. Ex. | 12.2 | 25 | X | ⊚ | 0 | 1 | X | ◯ | X |
| 59 | Comp. Ex. | 0.20 | 50 | X | — | — | — | — | — | X |
| 60 | Comp. Ex. | 0.48 | 50 | X | — | — | — | — | — | X |
| 61 | Comp. Ex. | 1.95 | 50 | Δ | ◯ | 0 | 4 | X | X | X |
| 62 | Comp. Ex. | 4.8 | 50 | X | ◯ | 0 | 2 | X | X | X |
| 63 | Comp. Ex. | 10.4 | 50 | X | ◯ | 0 | 2 | X | X | X |
| 64 | Comp. Ex. | 0.20 | 150 | X | — | — | — | — | — | X |
| 65 | Comp. Ex. | 0.48 | 150 | X | — | — | — | — | — | X |
| 66 | Comp. Ex. | 1.95 | 150 | X | — | — | — | — | — | X |
| 67 | Comp. Ex. | 4.8 | 150 | X | — | — | — | — | — | X |
| 68 | Comp. Ex. | 10.4 | 150 | X | — | — | — | — | — | X |
| 69 | Comp. Ex. | 0.20 | 250 | X | — | — | — | — | — | X |
| 70 | Comp. Ex. | 0.48 | 250 | X | — | — | — | — | — | X |
| 71 | Comp. Ex. | 1.95 | 250 | X | — | — | — | — | — | X |
| 72 | Comp. Ex. | 4.8 | 250 | X | — | — | — | — | — | X |
| 73 | Comp. Ex. | 10.4 | 250 | X | — | — | — | — | — | X |
| 74 | Ex. | 2.0 | 5.0 | ⊚ | ⊚ | 5 | 5 | ⊚ | ⊚ | ⊚ |
| 75 | Ex. | 2.0 | 5.0 | ⊚ | ⊚ | 5 | 5 | ⊚ | ⊚ | ⊚ |
| 76 | Ex. | 2.0 | 5.0 | ⊚ | ⊚ | 5 | 5 | ⊚ | ⊚ | ⊚ |
| 77 | Ex. | 2.8 | 5.0 | ⊚ | ⊚ | 5 | 5 | ⊚ | ⊚ | ⊚ |

### (Experiment by Varying the Amount of Carbon in the Steel)

Sn was plated on the surfaces of the steel sheets containing C in amounts as shown in Table 3 in a manner that the amount of free Sn after the reflow treatment was 2.1 g/m², followed by the reflow treatment and, thereafter, a solution of aminosilane coupling agent (γ-aminopropyltrimethoxysilane) was applied thereon and was dried to obtain surface-treated steel sheets having an Si content of 5.0 mg/m². Like the materials of samples Nos. 1 to 73, the inner surfaces thereof were coated and the outer surfaces thereof were coated and printed but leaving the welding margin portions to prepare blanks which were, then, compared for their weldabilities. Other conditions of the steel sheets, method of evaluating the weldability and the basis of evaluation were the same as those of samples Nos. 1 to 73. The welded cans could be stably produced when they were evaluated to be ⊚ and ◯.

Here, low-speed welding conditions consisted of a welding pressing force of 55 kgf and a welding speed of 15 m/min, and high-speed welding conditions consisted of a welding pressing force of 50 kgf and a welding speed of 55 m/min.

TABLE 3

Range of proper
welding current

| | Low-speed | High-speed |
|---|---|---|
| Amount of C % | welding | welding |
| 0.02 | ⊚ | ⊚ |
| 0.04 | ⊚ | ⊚ |
| 0.06 | ⊚ | ⊚ |
| 0.08 | ⊚ | ◯ |
| 0.10 | ⊚ | ◯ |
| 0.11 | ⊚ | Δ |
| 0.13 | ◯ | X |
| 0.36 | X | X |

1. A surface-treated tin-plated steel sheet for welded cans forming a surface-treating layer comprising chiefly a silane coupling agent on the surface of a tin-plated layer formed on the surface of a steel sheet, wherein the amount of free tin (Sn) (X g/m²) in the tin-plated layer and the amount of silicon (Si) (Y mg/m²) in the surface-treating layer lie in ranges satisfying all of the following formulas;
0.2≦X≦13
Y≧1.0
Y≦1.58X+6.92
Y≦−0.36X+10.70.

2. The surface-treated tin-plated steel sheet for welded cans according to claim 1, wherein a tin-iron alloy layer is formed between the surface of the steel sheet and the tin-plated layer.

3. The surface-treated tin-plated steel sheet for welded cans according to claim 2, wherein nickel is contained in the tin-iron alloy layer.

4. The surface-treated tin-plated steel sheet for welded cans according to claim 1, wherein the silane coupling agent is a water-soluble silane coupling agent containing amino silane.

5. The surface-treated tin-plated steel sheet for welded cans according to claim 1, wherein the steel sheet comprises a steel containing carbon in an amount of not larger than 0.10% by weight.

6. The surface-treated tin-plated steel sheet for welded cans according to claim 1, wherein an organic resin coating is formed on the surface-treating layer.

7. A welded can formed by using the surface-treated tin-plated steel sheet for welded cans of claim 1.
